(19) United States
(12) Patent Application Publication
(10) Pub. No.: US 2006/0194919 A1
(43) Pub. Date: Aug. 31, 2006

(54) Porosity control with polyhedral oligomeric silsesquioxanes

(76) Inventors: Joseph D. Lichtenhan, Petal, MS (US); Joseph J. Schwab, Huntington Beach, CA (US); Yi-Zhong An, Irvine, CA (US); Jack Sammons, Louisville, KY (US)

Correspondence Address: PILLSBURY WINTHROP SHAW PITTMAN LLP, P.O. BOX 10500, MCLEAN, VA, 22102, US

(21) Appl. No.: 11/354,583

(22) Filed: Feb. 14, 2006

Related U.S. Application Data
(63) Continuation-in-part of application No. 11/225,607, filed on Sep. 12, 2005.
(63) Continuation-in-part of application No. 11/166,008, filed on Jun. 24, 2005.
Application No. 11/166,008 is a continuation of application No. 09/631,892, filed on Aug. 4, 2000, now Pat. No. 6,972,312.
Application No. 11/166,008 is a continuation of application No. 10/351,292, filed on Jan. 23, 2003, now Pat. No. 6,933,345.
Application No. 11/166,008 is a continuation-in-part of application No. 09/818,265, filed on Mar. 26, 2001, now Pat. No. 6,716,919.
Application No. 11/166,008 is a continuation of application No. 09/747,762, filed on Dec. 21, 2000, now Pat. No. 6,911,518.
Application No. 11/166,008 is a continuation of application No. 10/186,318, filed on Jun. 27, 2002, now Pat. No. 6,927,270.
(60) Provisional application No. 60/652,922, filed on Feb. 14, 2005.
(60) Provisional application No. 60/608,582, filed on Sep. 10, 2004.
(60) Provisional application No. 60/147,435, filed on Aug. 4, 1999.
(60) Provisional application No. 60/351,523, filed on Jan. 23, 2002.
(60) Provisional application No. 60/192,083, filed on Mar. 24, 2000.
(60) Provisional application No. 60/171,888, filed on Dec. 23, 1999.

(51) Int. Cl. C08K 3/34; B32B 27/00

(52) U.S. Cl. 524/730; 428/405; 428/447

(57) ABSTRACT

The use of nanostructured chemicals based on polyhedral oligomeric silsesquioxanes (POSS) and polyhedral oligomeric silicates (POS) are used to control porosity in organic and inorganic media. The precisely defined nanoscopic dimensions of this class of chemicals enables porosity to be both created (increased) or reduced (decreased) as desired. The thermal and chemical stability of the POSS/POS nanostructures and the ability of these nano-building blocks to be selectively placed or rationally assembled with both inorganic and organic material mediums allow tailoring of porosity.

### RELATED APPLICATIONS

This application claims the benefit of U.S. Provisional Application Serial No. 60/652,922 filed Feb. 14, 2005, and is a continuation-in-part of U.S. patent application Ser. No. 11/225,607 filed Sep. 12, 2005 (which claims priority from U.S. Provisional Patent Application Serial No. 60/608,582 filed Sep. 10, 2004), which is a continuation-in-part of U.S. patent application Ser. No. 11/166,008 filed Jun. 24, 2005, which is (a) a continuation of U.S. patent application Ser. No. 09/631,892 filed Aug. 14, 2000, now U.S. Pat. No. 6,972,312 (which claims priority from U.S. Provisional Patent Application Serial No. 60/147,435, filed Aug. 4, 1999); (b) a continuation of U.S. patent application Ser. No. 10/351,292, filed Jan. 23, 2003, now U.S. Pat. No. 6,933,345 (which claims priority from U.S. Provisional Patent Application Serial No. 60/351,523, filed Jan. 23, 2002), which is a continuation-in-part of U.S. patent application Ser. No. 09/818,265, filed Mar. 26, 2001, now U.S. Pat. No. 6,716,919 (which claims priority from U.S. Provisional Patent Application Serial No. 60/192,083, filed Mar. 24, 2000); (c) a continuation of U.S. patent application Ser. No. 09/747,762, filed Dec. 21, 2000, now U.S. Pat. No. 6,911,518 (which claims priority from U.S. Provisional Patent Application Serial No. 60/171,888, filed Dec. 23, 1999); and (d) a continuation of U.S. patent application Ser. No. 10/186,318, filed Jun. 27, 2002, now U.S. Pat. No. 6,927,270 (which claims priority from U.S. Provisional Patent Application Serial No. 60/147,435, filed Jun. 27, 2001). The disclosures of the foregoing applications are incorporated herein by reference.

### BACKGROUND OF THE INVENTION

Polymeric silsesquioxane resins, networked spherosilicates and oligomeric silsesquioxanes, and networked hybrid (inorganic-organic) materials have all been reported to afford materials with various degrees of porosity. Porous materials have great commercial utility as filters, membranes, for control of material transport, and for thermally and electrical insulative applications in electronics and construction. Molecular level control over the size, shape, and distribution of the porosity in such devices has not fully been achieved because building blocks with rigid and well defined structural elements have not been available. The invention of nanostructured chemicals based upon the polyhedral oligomeric silsesquioxane (POSS) class of silsesquioxanes chemical systems affords such tools for the design and control of porosity in both inorganic and organic material systems.

Nanoscopic POSS building blocks have been used to modify the surfaces of metals to improve their corrosion resistance and to compatibilize fillers, thus demonstrating their utility for surface modification. POSS building blocks have also been used to form immobilized catalysts upon incorporation into zeolites.

This prior art has failed to recognize the use of POSS nanobuilding blocks as agents for specifically and rationally controlling the porosity in materials. The nanoscopic sizes of POSS-based chemicals provide an excellent and unprecedented set of tools for both creating porosity or for reducing porosity of a material with large pores. When utilized in this manner, porosity modification via POSS entities can yield materials with improved transport properties and selectivity for gasses and/or liquids. In addition, the thermal and electrical conductivity properties can also be controlled through the introduction of POSS as nanoscopic porogens.

### SUMMARY OF THE INVENTION

This invention teaches the use of nanostructured POSS chemicals as agents for the introduction of nanoscopic pores into polymers and as porosity modifiers for macro- and nano- porous materials. The nanoscopic features provided by the POSS agents further serve to compatibilize and provide multi-scale levels of reinforcement in polymeric coatings, composites, zeolites, minerals, and nanocomposites. POSS-surface modification agents can be incorporated into polymers using compounding, reactive processing and grafting and can be applied to zeolites, mineral and fillers using all conventional coating techniques including slurry, coating, painting spraying, flowing and vapor deposition. A wide variety of POSS formula are readily available from commercial silane feedstocks.

Definition of Formula Representations for Nanostructures

For the purposes of understanding this invention's nanostructured chemical compositions the following definition for formula representations of Polyhedral Oligomeric Silsesquioxane (POSS) and Polyhedral Oligomeric Silicate (POS) nanostructures is made.

[(RSiO_{1.5})ₙ(R′SiO_{1.5})ₘ]_{Σ#} for heteroleptic compositions (where R≠R′)

[(RSiO_{1.5})ₙ(RXSiO_{1.0})ₘ]_{Σ#} for functionalized heteroleptic compositions (where R groups can be equivalent or inequivalent).

In all of the above R=organic substituent (H, siloxy, cyclic or linear aliphatic or aromatic groups that may additionally contain reactive functionalities such as alcohols, esters, amines, ketones, olefins, ethers or halides). X includes but is not limited to OH, Cl, Br, I, alkoxide (OR), acetate (OOCR), peroxide (OOR), amine (NR₂) isocyanate (NCO), and R. The symbols m and n refer to the stoichiometry of the composition. The symbol Σ indicates that the composition forms a nanostructure and the symbol # refers to the number of silicon atoms contained within the nanostructure. The value for # is usually the sum of m+n. It should be noted that Σ# is not to be confused as a multiplier for determining stoichiometry, as it merely describes the overall nanostructural characteristics of the system (aka cage size).

Nanostructured chemicals are defined by the following features. They are single molecules and not compositionally fluxional assemblies of molecules. They possess polyhedral geometries with well-defined three-dimensional shapes. Clusters are good examples whereas planar hydrocarbons, dendrimers and particulates are not. They have a nanoscopic size that ranges from approximately 0.7 nm to 5.0 mn. Hence, they are larger than small molecules but smaller than macromolecules. They have systematic chemistries that enable control over stereochemistry, reactivity and their physical properties. “Molecular silicas” refers to nanostructured chemicals that possess no reactive groups for grafting or polymerization.

### IN THE FIGURES

FIG. 1 shows the anatomy of a POSS nanostructured chemical;

FIG. 2 shows the physical size relationships of a traditional silane applied to a surface as a monolayer (left) and nanostructured coupling agents applies as monolayers;

FIG. 3 illustrates inter and intramolecular free volume for a polymer chain;

FIG. 4 illustrates accessible porosity relative to morphology in polymer systems;

FIG. 5 shows examples of monodisperse molecular silicas;

FIG. 6 illustrates a molecular silica alloyed into a polymer; and

FIG. 7 shows representative reduction of a zeolite pore by POSS.

### DETAILED DESCRIPTION OF THE INVENTION

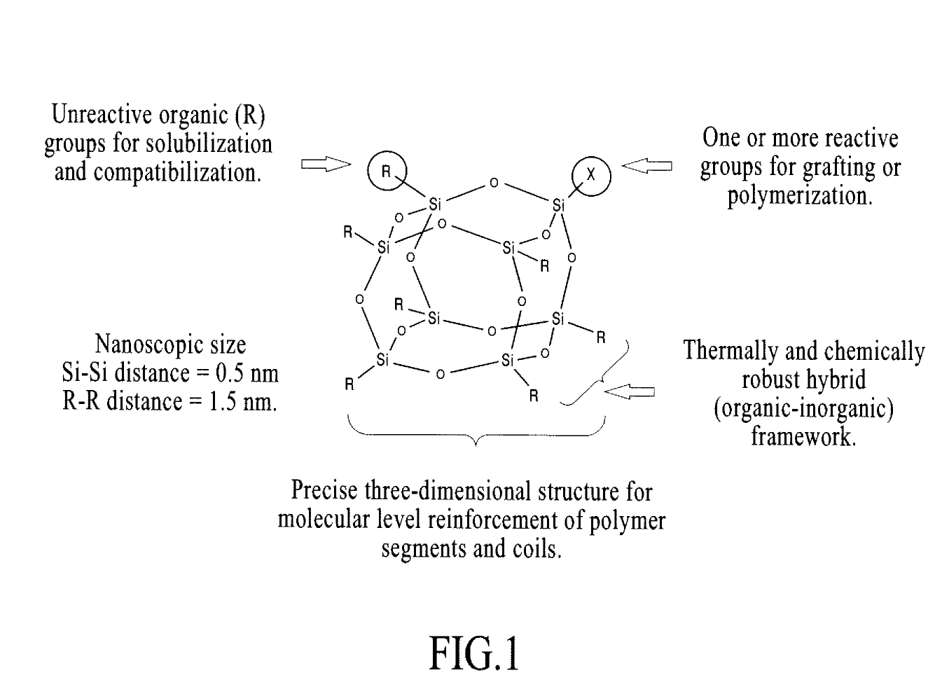

A structural representation for nanostructured chemicals based on the class of chemicals known as polyhedral oligomeric silsesquioxanes (POSS) is shown in FIG. 1.

Their features include a unique hybrid (organic-inorganic) composition that possesses many of the desirable physical characteristics of both ceramics (thermal and oxidative stability) and polymers (processability and toughness). In addition they possess an inorganic skeleton which is externally covered by compatiblizing organic groups R and reactive groups X where R=organic substituent (H, siloxy, cyclic or linear aliphatic or aromatic groups that may additionally contain reactive functionalities such as alcohols, esters, amines, ketones, olefins, ethers or halides). X includes but is not limited to OH, Cl, Br, I, alkoxide (OR), acetate (OOCR), peroxide (OOR), amine (NR₂) isocyanate (NCO), olefin, and R. This inorganic skeleton coupled with the peripheral groups combines to form chemically precise cubic-like low density building blocks that incorporated in to polymers via co-polymerization have been shown to improve gas diffusion and selectivity properties.

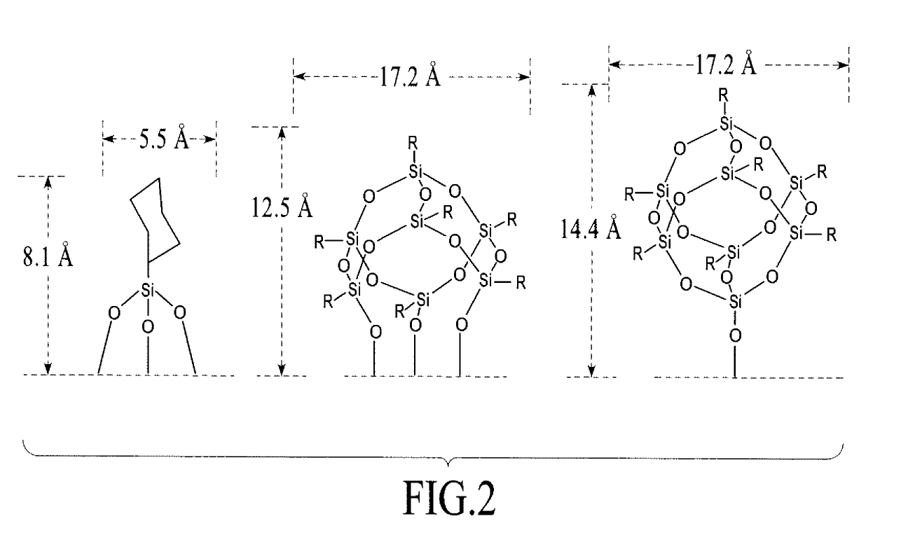

A particularly advantageous feature provided by nanostructured surface modification agents, like POSS, is that a single molecule is capable of providing five times the surface area coverage relative to that provided by comparable silane coupling agents applied in the hypothetical monolayer fashion. The dimensions utilized for the example in FIG. 2 are taken from single crystal X-ray data for systems where R=cyclohexyl.

Surface modifications using POSS-mercapto systems have been shown to be advantageous in both aiding the despersibility of fillers and in improving their interfacial compatibility. When applied to surfaces nanostructured chemicals provide the advantage of multi-length scale reinforcement where the macroscopic filler reinforces at the micron level and higher (micron=10⁻⁶ meters) and the POSS-surface modification agents reinforce at nanometer dimensions (nm=10⁻⁹ meters).

Nanostructured Chemicals for Controlling Polymer Porosity

The improvement of polymer permeabilities through copolymerization of POSS-monomers into acrylic resins has been demonstrated. This invention however teaches the use of POSS molecular silicas as porosity modification agents in polymers and in macroporous materials such as zeolites and molecular sieves.

Prior art associated with fillers and morphology control has not been able to adequately control polymer porosity at a molecular level due to the absence of appropriately sized and structurally rigid nanoreinforcements with both controlled diameters, distributions and with tailorable chemical functionality. Furthermore the mismatch of chemical potential (solubility, miscibility) between hydrocarbon-based polymers and inorganic-based fillers resulted in a high level of heterogeneity in compounded polymers.

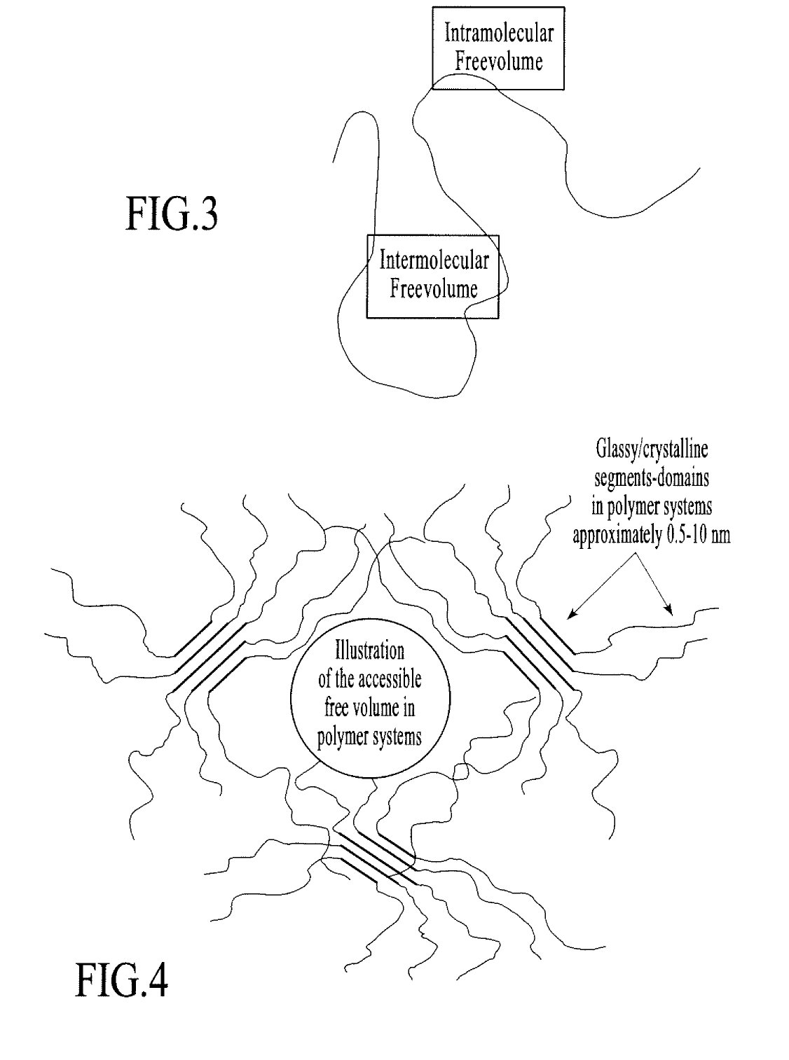

The keys that enable nanostructured chemicals to function as molecular level porogens are (1) their unique size with respect to polymer chain dimensions and (2) their ability to be compatibilized and overcome repulsive forces that induce incompatibility and expulsion of the nanoreinforcing agents by the polymer chains. It has long been known that in the solid-state all polymers, including amorphous, semi-crystalline, crystalline, rubbers etc., possess considerable amounts of internal and external free volume (FIG. 3).

The amount of free volume present is highly dependent upon the polymer composition, morphology, and the thermodynamic and kinetic factors associated with its nonequilibrium and equilibrium properties. The free volume of a polymer has a tremendous impact on its physical properties, since it is within this volume that the properties such as thermal conductivity, gas/liquid diffusion and permeability are controlled.

Polymer morphology is another factor that contributes greatly to the accessibility of free volume in a polymer system. For example, denser regions or phase separation within a polymer can both increase and decrease the thermodynamic and kinetic access to such regions (FIG. 4).

The size of POSS is roughly equivalent to that of most polymer dimensions, thus at a molecular level POSS can effectively introduce porosity into existing polymer morphologies (see Table 1).

TABLE 1
Relative sizes of POSS, polymer dimensions, and fillers.

| Particle Type | Particle Diameter | |
|---|---|---|
| Amorphous Polymer Segments | 0.5-5 | nm |
| Octacyclohexyl POSS 6808 | 1.5 | nm |
| Random Polymer Coils | 5-10 | nm |
| Colloidal Silica | 9-80 | nm |
| Crystalline Lamellae | 1.0-9,000 | nm |
| Fillers/Organoclays | 2-100,000 | nm |

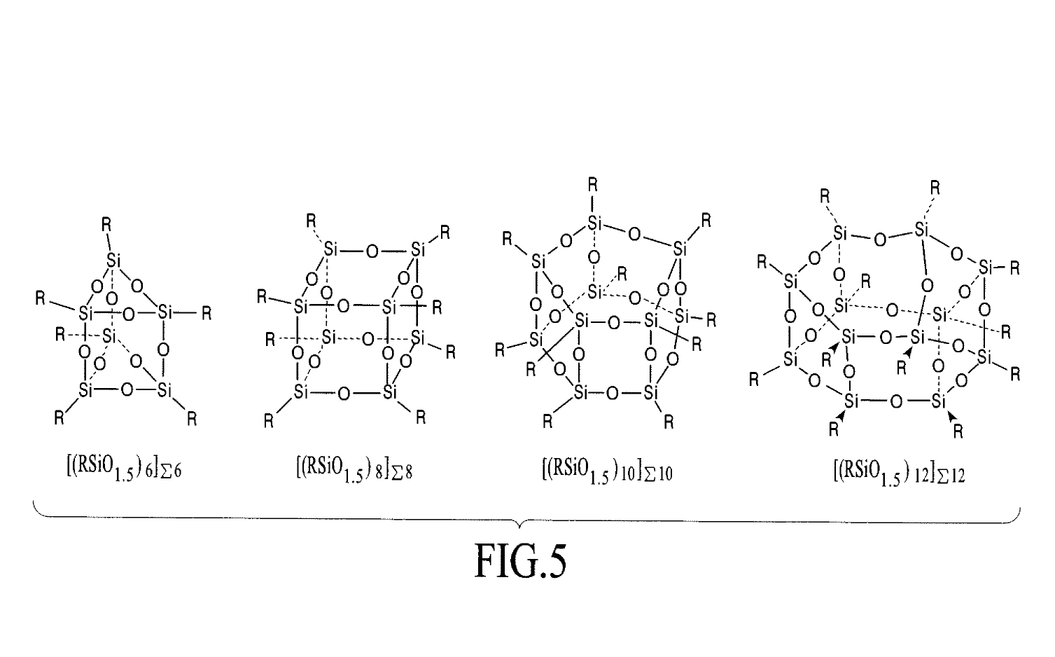

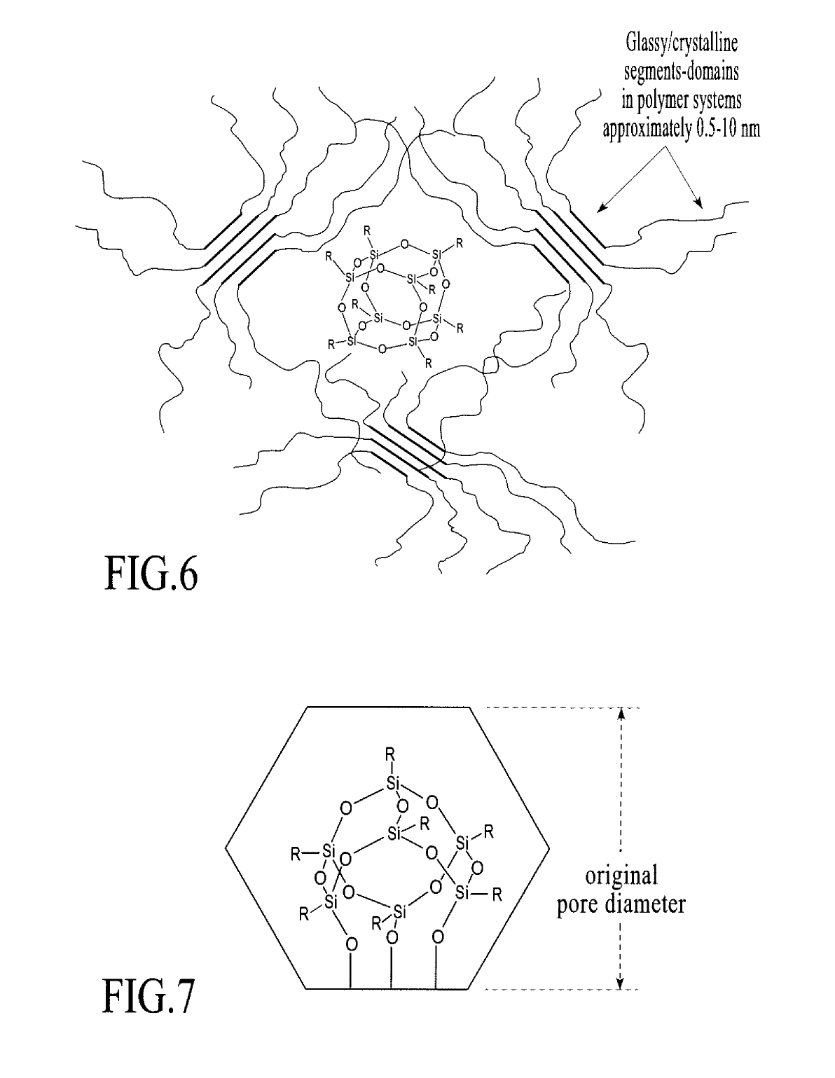

POSS's ability to occupy specific sites within the amorphous and crystalline region of polymers enables alteration of the size of the porosity contained within the polymer. The availability of a wide range of sizes of POSS nanostructures (cages) further augments this capability (FIGS. 5, 6).

Furthermore, because POSS nanostructured chemicals possess spherical shapes, like molecular spheres, and because they dissolve and melt, they are also effective at reducing the viscosity of polymer systems. Viscosity reduction is desirable for the processing of highly filled and high viscosity plastics.

The nonreactive incorporation of molecular silicas into polymers through conventional blending techniques greatly enhances the permeabilities of common plastics (Table 2).

The degree of enhancement is dependent upon the size of the silicon-oxygen cage, the overall size of the nanostructure (R-group effects), the wt % (or volume %) of incorporation, and the interfacial compatibility between the polymer and the nanostructure. The ability to control and tailor these features affords permeability increases ranging from one to three orders of magnitude in common commercial grade polymers. Furthermore, the gas selectivity of these alloyed polymers can be controlled through a similar manipulation of these variables. In some cases both selectivity and permeability have been simultaneously improved relative to the base polymer. In all cases the incorporation of POSS-monomers, POSS-resins, molecular silicas results in the retardation of permeability for carbon dioxide relative to all other gases.

TABLE 2
Comparative Gas Permeabilities.

| | N₂ | O₂ | CO₂ | CH₄ |
|---|---|---|---|---|
| HDPE | 51 | 225 | 542 | — |
| LDPE | 219 | 610 | 3,294 | — |
| PP | 69 | 345 | 1,152 | — |
| PC | — | — | — | — |
| PP-10% [(VinylSiO_{1.5})₁₀]Σ₁₀ | 2,977 | 3,209 | 4,500 | 905 |
| PP-30% [(VinylSiO_{1.5})₁₀]Σ₁₀ | 882,000 | 933,282 | 335,397 | 1,276,274 |
| PP-50% [(VinylSiO_{1.5})₁₀]Σ₁₀ | — | — | — | — |
| PP-10% [(PhenylSiO_{1.5})₁₂]Σ₁₂ | — | — | — | — |
| PP-30% [(PhenylSiO_{1.5})₁₂]Σ₁₂ | 141,741 | 92,756 | 55,683 | 108,670 |
| PP-50% [(PhenylSiO_{1.5})₁₂]Σ₁₂ | 120,022 | 87,444 | 50,104 | 103,292 |
| PP-10% [(MethylSiO_{1.5})₈]Σ₈ | 7,189 | 6,382 | 5,284 | 8,650 |
| PP-30% [(MethylSiO_{1.5})₈]Σ₈ | 62,533 | 59,911 | 59,818 | 98,923 |
| PP-50% [(MethylSiO_{1.5})₈]Σ₈ | — | — | — | — |
| PP-10% [(IsobutylSiO_{1.5})₈]Σ₈ | 5,740,000 | 5,670,000 | 3,330,000 | 7,980,000 |
| PP-30% [(IsobutylSiO_{1.5})₈]Σ₈ | — | — | — | — |
| PP-50% [(IsobutylSiO_{1.5})₈]Σ₈ | — | — | — | — |
| PE-10% [(VinylSiO_{1.5})₁₀]Σ₁₀ | — | — | — | — |
| PE-30% [(VinylSiO_{1.5})₁₀]Σ₁₀ | — | — | — | — |
| PE-50% [(VinylSiO_{1.5})₁₀]Σ₁₀ | — | — | — | — |
| PE-10% [(PhenylSiO_{1.5})₁₂]Σ₁₂ | 901 | — | — | — |
| PE-30% [(PhenylSiO_{1.5})₁₂]Σ₁₂ | — | — | — | — |
| PE-50% [(PhenylSiO_{1.5})₁₂]Σ₁₂ | — | — | — | — |
| PE-10% [(MethylSiO_{1.5})₈]Σ₈ | 0 | — | — | — |
| PE-30% [(MethylSiO_{1.5})₈]Σ₈ | — | — | — | — |
| PE-50% [(MethylSiO_{1.5})₈]Σ₈ | — | — | — | — |
| PE-10% [(IsobutylSiO_{1.5})₈]Σ₈ | 1,600,000 | — | — | — |
| PE-30% [(IsobutylSiO_{1.5})₈]Σ₈ | — | — | — | — |
| PE-50% [(IsobutylSiO_{1.5})₈]Σ₈ | — | — | — | — |
| PC-10% [(PhenylSiO_{1.5})₁₂]Σ₁₂ | — | — | — | — |
| PC-30% [(PhenylSiO_{1.5})₁₂]Σ₁₂ | — | — | — | — |
| PC-50% [(PhenylSiO_{1.5})₁₂]Σ₁₂ | — | — | — | — |

Permeability Units: cc-mil/sqft/day/atm.
PP = polypropylene,
HDPE = high density polyethylene,
LDPE = low density polyethylene,
PC = polycarbonate

Nanostructured Chemicals for Controlling Properties and Porosity of Zeolites

POSS-reagents and in particular POSS-silanols are also proficient at coating the interior surfaces of minerals, zeolites and in particular layered silicates. When applied as coatings to zeolites or other porous materials the POSS-entity can effectively reduce the pore size openings and impart greater compatibility of the pore toward selective entry and exit of gases and other molecules. This enhanced compatibility directly results from the compatibilizing influence of the organic R-groups located on each of the comers of the POSS cage. The ability of these R groups to enable compatibility is directly derived from the principal of like dissolves like. This fundamental principal simply states that substances of like composition (or chemical potential) are more compatible than substances for dissimilar composition. Hence, through the proper match of R substituent on the POSS-cage, POSS can modify silicates and other like materials and thereby compatibilize them with organic and inorganic compositions.

The ability of POSS to be effectively immobilized upon the interior surfaces of molecular sieves has been demonstrated for the purposes of improving the effectiveness and durability of POSS-based catalysts. In a related manner POSS-silanols which can be bonded to the interior surfaces of all naturally occuring and synthetic silicas, zeolites, and molecular sieves to selectively and rationally reduce the pore sizes in such materials (FIG. 7).

POSS-silanols will bond to the interior (and exterior) surfaces of such materials through the elimination of water to form thermally stable covalent linkages. Once bound to the interior surface of a pore in a molecular sieve, the POSS will thereby reduce the effective diameter of the pore by an amount equal to its diameter. For example, the diameter of a 5 Å molecular sieve containing a POSS-silanol of diameter 1.5 Å would be effectively reduced to a pore size of 3.5 Å. Pore size reduction in such materials would therefore render them effective for the separation of gases in accordance to their molecular or working diameters (Table 3).

TABLE 3
Comparative molecular diameters and molecular weights of gases.

| | H₂ | N₂ | O₂ | CO | CO₂ | CH₄ | H₂O |
|---|---|---|---|---|---|---|---|
| Molecular Gas | 2.9 | 3.6 | 3.5 | 3.7 | 3.3 | 3.8 | 2.9 |
| Diameters (Å) | | | | | | | |
| Molecular Weight | 2.0 | 28.0 | 32.0 | 28.0 | 44.0 | 16.0 | 18.0 |
| (g/mole) | | | | | | | |

The degree of pore reduction that can be accomplished through such a method is dependant upon the size of the silicon-oxygen cage and the overall size of the nanostructure. The interfacial compatibility of the POSS coated molecular sieve will also be enhanced through the choice of the R-group on the POSS nanostructure.

The separation of gases according to their physical diameters is desirable as it results in higher separation rates and selectivities. Gas separations based on Graham's law are conducted relative to the molecular weight of a gas molecule which typically results in a high separation rate but low selectivity. Alternately, gas separations base on Henry's law utilize solution diffusion and consequently have low separation rates. Gas separation based on nanoscopic pores or equivalent nanoscopic hole sizes offers both a high rate of separation and high selectivity.

### EXAMPLES

Alloying Polymers with Molecular Silicas. Prior to compounding all molecular silicas and polymers should be predried at 60° C. to 100° C. under vacuum for three hours or via a similarly effective procedure to ensure removal of traces of water. Molecular silicas are introduced using a weight loss feeder at the desired wt % into the barrel of a twinscrew compounder containing polypropylene operating at 120 RPM and operating at 190° C. The residence time can be varied from 1 min to 10 min prior to extrusion and pellatization, grinding, or molding of the alloyed polymer.

Solvent Assisted Application Method for Coating Molecular Sieves. POSS-trisilanols (100 g) are dissolved in a 400 ml of dichlormethane. To this mixture was added 500 g of 4 Å molecular sieves. The mixture was then stirred at room temperature for 30 minutes. The volatile solvent was then removed and recovered under vacuum. It should also be noted that supercritical fluids such as CO₂ can also be utilized as a replacement for flammable hydrocarbon solvents. The resulting free flowing solid may then be either used directly or subjected to mild heat treatment of approximately 120° C. prior to use. If desired the heat treated material may then be rinsed with dichloromethane to remove traces of nonbound material.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for adjusting the permeability of a polymer comprising compounding a nanostructured material selected from the group consisting of POSS and POS into a polymer.

2. The method of claim 1, wherein the nanostructured chemical is a molecular silica.

3. The method of claim 1, wherein the nanostructured chemical is compounded into the polymer using a process selected from the group consisting of melt compounding, milling, solvent processing, and solventless processing.

4. The method of claim 1, wherein the polymer is selected from the group consisting of acrylics, carbonates, epoxies, esters, silicones, styrenics, amides, nitrites, olefins, aromatic oxides, aromatic sulfides, and ionomers or rubbery polymers derived from hydrocarbons and silicones.

5. The method of claim 1, wherein a physical property of the polymer is modified as a result of the compounding, and the property is selected from the group consisting of gas separation, reduced thermal conductivity, and reduced electrical conductivity.

6. The method of claim 3, wherein the process is a solventless process technique using molten-state processing.

7. A method for adjusting the permeability of a zeolite or a molecular sieve, comprising coating the zeolite or the molecular sieve with a nanostructured material selected from the group consisting of POSS and POS.

8. The method of claim 7, wherein a physical property of the zeolite or the molecular sieve is modified as a result of the coating, and the property is selected from the group consisting of gas separation, reduced thermal conductivity, and electrical conductivity.

9. The method of claim 7, wherein the zeolite or the molecular sieve is coated with the nanostructured chemical using a technique selected from the group consisting of solventless techniques and super critical fluid assisted techniques.

10. The method of claim 9, wherein the technique is a processing method selected from the group consisting of molten-state, spray, flow and mixing processing methods.

11. The method of claim 1 wherein the nanostructured material is selected from the group consisting of [(RSiO_{1.5})₄(RXSiO_{1.0})₃]_{Σ7}, polysilsesquioxanes [(RSiO_{1.5})ₙ]_{Σ#}, and POSS fragments [(RSiO_{1.5})ₘ(RXSiO_{1.0})ₙ]_{Σ#}.

12. The method of claim 7, wherein the nanostructured material is derived from a compound selected from the group consisting of POSS-silanols, siloxides of the formula [(RSiO_{1.5})₄(RXSiO_{1.0})₃]_{93 7}, polysilsesquioxanes [(RSiO_{1.5})ₙ]_{Σ#}, and POSS fragments [(RSiO_{1.5})ₘ(RXSiO_{1.0})ₙ]_{93 #}.
